(19) United States
(12) Patent Application Publication
(10) Pub. No.: US 2018/0149485 A1
(43) Pub. Date: May 31, 2018

(54) ROAD DISTANCE SYSTEMS AND METHODS

(71) Applicant: UNIVERSITY OF MARYLAND, COLLEGE PARK, College Park, MD (US)

(72) Inventors: Hanan SAMET, College Park, MD (US); Shangfu PENG, Silver Spring, MD (US)

(73) Assignee: UNIVERSITY OF MARYLAND, COLLEGE PARK, College Park, MD (US)

(21) Appl. No.: 15/574,701

(22) PCT Filed: May 18, 2016
(86) PCT No.: PCT/US16/33094

§ 371 Date: Nov. 16, 2017

Related U.S. Application Data
(60) Provisional application No. 62/162,900, filed on May 18, 2015.
(60) Provisional application No. 62/314,795, filed on Mar. 29, 2016.

(51) Int. Cl. G01C 21/34; G01C 21/36; G01C 21/32; G06F 17/30

(52) U.S. Cl. CPC G01C 21/3446; G01C 21/3697; G06F 17/30241; G06F 17/30864; G01C 21/32

(57) ABSTRACT

Various computational systems may benefit from enhanced systems for computing multiple network distance queries. For example, systems requiring high throughput of numerous network distance queries may benefit from systems and method that can utilize all-store and other distance oracles, including integrated architecture systems. A method can include selecting a subset of vertices from a provided set of vertices. The method can also include precomputing distances between the selected subset of vertices. The method can further include storing the precomputed distances in all-store distance oracles. The method can additionally include answering a travel query based on the all-store distance oracles.

### CROSS-REFERENCE TO RELATED APPLICATION

This application is related as a non-provisional of, and claims the benefit and priority of, U.S. Provisional Patent Application No. 62/314,796 filed Mar. 29, 2016, which is hereby incorporated herein by reference in its entirety. This application is also related as a non-provisional of, and claims the benefit and priority of, U.S. Provisional Patent Application No. 62/162,900 filed May 18, 2015, which is hereby incorporated herein by reference in its entirety.

### GOVERNMENT LICENSE RIGHTS

This invention was made with government support under IIS1320791 awarded by NSF and with government support under IIS1219023 awarded by NSF. The government has certain rights in the invention.

### BACKGROUND

### Field

Various computational systems may benefit from enhanced systems for computing multiple network distance queries. For example, systems requiring high throughput of numerous network distance queries may benefit from systems and method that can utilize all-store and other distance oracles, including integrated architecture systems.

### Description of the Related Art

Traditional user interaction with computer mapping relates to a user obtaining a shortest path or travel time from a starting point to a destination, or to a set of destinations. For example, a traditional simple query is “Where is my nearest restaurant?” While conventional tools aim to address these relatively simple queries, these and more complex queries may pose a computational burden on systems designed to provide answers to such queries.

A spatial analytical query on a road network may perform hundreds of thousands or even millions of shortest distance computations in the process of answering the query. These types of queries are commonplace in many applications such as logistics, tour planning, and determining service areas.

For spatial analytical queries on road networks, there are two common reasons why such queries end up making a very large number of distance computations. First, spatial analytical queries are typically used for generating insights into the data in the form of reports or visual representations. So it is common for these queries to end up accessing large portions of the data. Second, the queries may join two or more datasets on the basis of the network distance to other objects on the road network, such as finding the nearest neighbors from one dataset for each location in another dataset, or group one or more datasets based on the closest distance to objects in another dataset. Executing all of these operations can easily end up making millions of distance computations on the road network. For instance, just the simple query that obtains the network distance between all pairs of objects drawn from a set of 1000 objects to one another ends up making 1 million distance computations on the road network.

Spatial analytical queries may be an important use-case whose efficiency depends on being able to compute millions of network distance computations efficiently on road networks. However, conventional tools are limited in their ability to efficiently address spatial analytical queries.

Spatial analytical queries make two distinct kinds of access patterns on road networks, and make millions of these accesses in the process of answering a query. The most basic pattern is called one-to-one pattern which computes the distance between a source and a destination on the road network. Another access pattern is one-to-many that makes several s-t pair computations from the same source vertex. For instance, computing the K nearest neighbors for each point from a large dataset makes one-to-many access patterns. There are opportunities for speeding up one-to-many patterns even though they are nothing more than multiple one-to-one access patterns. The term “scan” can be used to describe the actual implementation of the execution of an access pattern. There can be many options for executing a scan including Dijkstra's algorithm, contraction hierarchies (CH), and the like.

### SUMMARY

According to certain embodiments, a method can include selecting a subset of vertices from a provided set of vertices. The method can also include precomputing distances between the selected subset of vertices. The method can further include storing the precomputed distances in all-store distance oracles. The method can additionally include answering a travel query based on the all-store distance oracles.

In certain embodiments, an apparatus can include at least one processor and at least one memory including computer program code. The at least one memory and the computer program code can be configured to, with the at least one processor, cause the apparatus at least to select a subset of vertices from a provided set of vertices. The at least one memory and the computer program code can also be configured to, with the at least one processor, cause the apparatus at least to precompute distances between the selected subset of vertices. The at least one memory and the computer program code can further be configured to, with the at least one processor, cause the apparatus at least to store the precomputed distances in all-store distance oracles. The at least one memory and the computer program code can further be configured to, with the at least one processor, cause the apparatus at least to answer a travel query based on the all-store distance oracles.

An apparatus, according to certain embodiments, can include means for selecting a subset of vertices from a provided set of vertices. The apparatus can also include means for precomputing distances between the selected subset of vertices. The apparatus can further include storing the precomputed distances in all-store distance oracles. The apparatus can additionally include means for answering a travel query based on the all-store distance oracles.

A computer program produce can, in certain embodiments, encode instructions for performing a process. The process can include selecting a subset of vertices from a provided set of vertices. The process can also include precomputing distances between the selected subset of vertices. The process can further include storing the precomputed distances in all-store distance oracles. The process can additionally include answering a travel query based on the all-store distance oracles.

A non-transitory computer-readable medium can, according to certain embodiments, be encoded with instructions that, when executed in hardware, cause an apparatus at least to perform a process. The process can include selecting a subset of vertices from a provided set of vertices. The process can also include precomputing distances between the selected subset of vertices. The process can further include storing the precomputed distances in all-store distance oracles. The process can additionally include answering a travel query based on the all-store distance oracles.

### BRIEF DESCRIPTION OF THE DRAWINGS

For proper understanding of the invention, reference should be made to the accompanying drawings, wherein:

FIG. 1 illustrates a method according to certain embodiments.

FIG. 2 illustrates an oracle checking function, according to certain embodiments.

FIG. 3 illustrates an integrated architecture distance oracle for analytical queries, according to certain embodiments.

FIG. 4 illustrates an example of SQL coding of a query, according to certain embodiments.

FIG. 5 illustrates a distributed architecture for precomputing an all-store distance oracle, according to certain embodiments.

FIG. 6 illustrates two queries according to certain embodiments.

FIG. 7 illustrates a system according to certain embodiments of the invention.

FIG. 8 illustrates cluster-computing implementations of methods according to certain embodiments.

FIG. 9 illustrates algorithms for master programs, according to certain embodiments.

### DETAILED DESCRIPTION

Certain embodiments may overcome deficiencies of previous approaches to calculating distances in response to queries. For example, certain embodiments may provide improved throughput and easier implementation in a wider variety of computing systems. Likewise, certain embodiments may provide various benefits or advantages over systems that rely on Euclidian distances rather than network distances. Furthermore, certain embodiments provide an all-store distance oracle approach. By “all-store” it is included that the system can be embedded within any database system, such as with relational database management system (RDBMS), data warehouse, column-oriented database management system (DBMS), and large scale distributed stores, without requiring any specialized indices or similar modification to the database. For example, certain embodiments do not require modification to the database in terms of a Morton Index on the oracle relation.

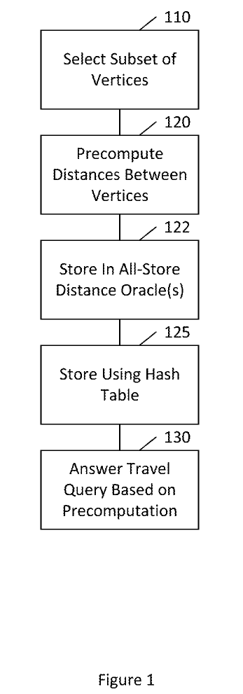

FIG. 1 illustrates a method according to certain embodiments. As shown in FIG. 1, a method can include, at 110, selecting a subset of vertices from a provided set of vertices. The vertices can be map locations, coordinate pairs, or other locations within a network, such as a road network. For example, the provided set vertices can be set of all potential starting points and destinations in a database. Vertices can also be referred to as nodes.

A road network G can be modeled as a weighted directed graph denoted by G(V,E,w,p), where V is a set of nodes or vertices, n=|V|,E⊂V×V is the set of edges, m=|E|, and w is a weight function that maps each edge e∈E to a positive real number w(e), for example, distance, time, fuel usage, toll amount, and so on. A property of road network is that

$$\frac{m}{n}$$

is typically a small positive number that is independent of n. In addition, each node v has p(v) denoting the spatial position of v with respect to a spatial domain S, which is also referred to as an embedding space. This spatial domain or embedding space can be for, example, a reference coordinate system in terms of latitude and longitude. The graph distance d_{G}(u, v) can be defined to be the shortest distance from u to v in the road network, while geodesic distance d_{E}(u, v) can be defined to the Euclidean distance from u to v. The graph distance can be dramatically longer than the geodesic distance, for example when a river or mountain range lies between the points.

A Morton (Z) order space-filling curve can be used to provide a mapping [symbol] ²→ [symbol] ₁ of a multidimensional object, such as a vertex or a quadtree block, in a two-dimensional embedding space to positive number. Given an object o, mc(o) can be the mapping function that produces the Morton representation of o by interleaving the binary representations of the object's coordinate values.

Given a spatial domain S, the Morton order of blocks in S can be obtained by subdividing the space into 2^{D}×2^{D} equal sized blocks named unit blocks, where D is a positive integer named the maximal decomposition depth.

Each unit block i can be referenced by a unique Morton code mc(i). There are two ways to represent Morton codes: number representation and string representation. A completed number representation can be associated with corresponding depth information. For example, (0, depth 2) can be equivalent to “0000”, and (0, depth 1) can be equivalent to “00”. The string representation may be useful for explanation purposes, while the number representation may be more efficient in practice.

A spatial graph G (V, E, w, p) on the domain S can also be divided into 2^{D}×2^{D} unit blocks. Given a vertex v in the unit block I, the Morton code mc(v) is equal to mc(i). All vertices located in the same block have the same Morton code. Besides the unit blocks, every larger block b has a unique Morton code, which the longest common prefix of all unit blocks contained in b in the string representation.

Given blocks A and B, a relationship between A and B can be defined such that the relationship exists if and only if block A is contained in block B and thus mc(B) is a prefix of mc(A), denoted as PREFIX(mc(B), mc(A)). If data is sorted in this order, the resulting blocks can be stored using any one-dimensional data structure such as, but not limited to, a B-tree.

The selecting a subset can include building a point region (PR) quadtree on the entire set of vertices based on the spatial position of the vertices. A PR quadtree can be a four-way search tree. Each node can have either four children, as in the case of an internal guide node, or zero children, as in the case of a leaf node. Keys may be stored only in the leaf nodes, with all internal nodes acting as guides towards the keys. A PR quadtree can follow the following rules: at most, one vertex can lie in a region represented by a quadtree leaf node; each region's quadtree leaf node is maximal; internal guide nodes are considered to be gray nodes; leaf nodes that contain data are considered to be black; leaf nodes that are empty (they simply exist to fulfill the 4-way property) are considered to be white; each gray node must have at least two children that are black and/or one child that is a valid gray node; and, if, after a deletion, a gray node has three white children and one black one, the gray node must be deleted and replaced by the black child node.

For quadtree block A, the Morton representation can be given by mc(A). The Morton code 0 can represent the root block, which spans the entire spatial domain S.

The selecting the subset can also include well-separated pair (WSP) decomposition of a block pair that is the largest potential oracle. The decomposition can begin with the block pair (S, S), which is the largest potential oracle. A potential oracle can be a pair of blocks that has not yet been examined, denoted as (A, B), where blocks A and B are at the same depth of the PR quadtree and represented by their Morton codes.

Two sets of vertices A and B can be said to be well separated if a minimum distance between any two vertices in A and B is at least s·r, where s>0 is a separation factor, and r is the larger diameter of the two sets. If the pair (A, B) is a well-separated pair, for any pair of vertices (s, t), s∈A and t∈B an approximate network distance can be provided by d_{ϵ}(A, B), where

$$ϵ = \frac{2}{s} ,$$

fulfilling the following condition:

(1−ϵ)·d_{ϵ}(A,B)≤d_{G}(s,t)≤(1+ϵ)·d_{ϵ}(A,B) (Equation 1).

The potential oracle can be checked to determine whether the potential oracle can be an accepted oracle. If so, the potential oracle can be saved as an accepted oracle. Otherwise, the potential oracle can be sub-divided to form new potential oracles, and these new potential oracles can then be similarly checked.

In order to check the oracle, all vertices in oracle can be sorted by their Morton code. Because each vertex v has a unique latitude and longitude, each vertex can have a unique Morton code mc(v). These sorted vertices can be put into an array C. For any block b in the PR quadtree, the minimum and maximum Morton code values bₘᵢₙ and bₘₐₓ in the oracle O(1) can be calculated by computing the Morton codes for the bottom left and upper right corners of C. Then a binary search in C can be performed to get the index range [bₛₜₐᵣₜ, b_{end}] such that C[i], i∈[bₛₜₐᵣₜ, b_{end}] corresponds to a sub-array that contains all vertices whose Morton codes are contained in the range denoted by [bₘᵢₙ, bₘₐₓ]. Another way of describing C[i] is that it contains all blocks in C whose prefix is mc(b).

During the process of checking the oracles, a system can create queue Q of current potential oracles to be checked. The first entry in the queue can be (S, S), as mentioned above. Each potential oracle can be examined in turn. When an oracle is not accepted, new potential oracles can be generated and these can be added to Q.

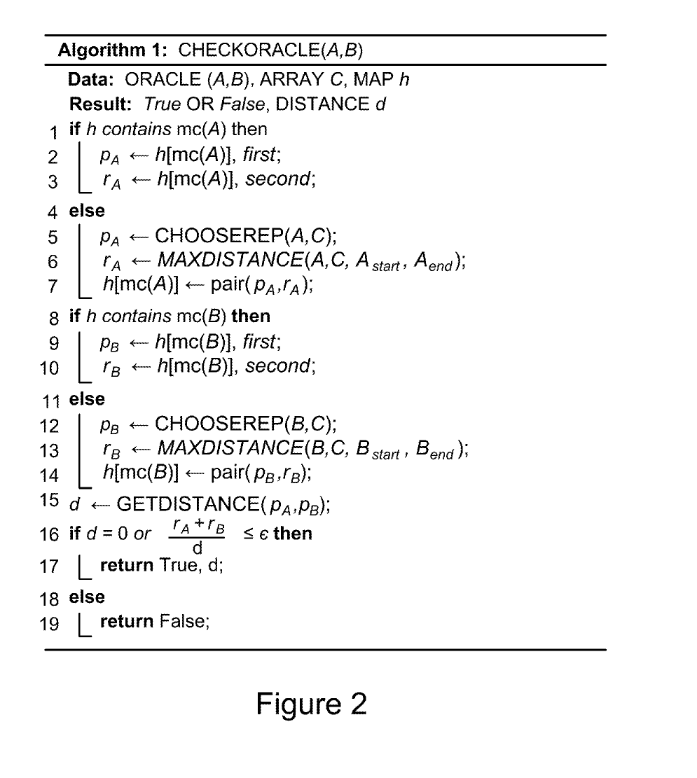

FIG. 2 illustrates an oracle checking function, according to certain embodiments. The algorithm shown in FIG. 2 is just one example of a possible algorithm for implementing this function. A potential oracle (A, B) can be given to CheckOracle(A,B) as shown in FIG. 2, which can return “true” if the network distances between all pairs of vertices in (A, B) can indeed be approximated by a single approximate value. In that case, the potential oracle can become an accepted oracle and can be added to the all-store distance oracle. IF the function returns “false”, then the potential oracle (A, B) can be subdivided into 4×4 new potential oracles by subdividing A and B once into their children quadtree blocks. The resulting potential oracles can be inserted into Q and the processing of Q can continue with examination of a next potential oracle.

The selecting the subset can include selecting a representative vertex from each block under consideration. The representative vertex can be chosen in a variety of ways. For example, the representative vertex can be chosen randomly from within the oracle. Alternatively, the representative vertex can be chosen arbitrarily from within the oracle, such as the first, last, or middle vertex within a set of vertices contained in the oracle. As a further example, the representative vertex can be selected to be the center-most vertex within the oracle, such as the vertex that minimizes the distance to the farthest vertex from it, namely the graph center. As another example, the representative vertex can be selected as the vertex closest to the geographic center of the block, namely the geographic center.

In FIG. 2, the representative vertex choosing function is labeled ChooseRep( ). This function may implement any of the approaches set forth above. Furthermore, the representative vertex choosing function can take into the number of vertices being considered. For example, if the number is less than a threshold, then the graph method can be used, otherwise the geographic method can be used. One example of such a threshold may be 2000 vertices.

Once a representative vertex has been computed, a maximum distance value can be obtained for the block. The maximum distance can be the greatest distance from the representative vertex to the other vertices in the block. This maximum distance can be referred to as the radius of the block.

In FIG. 2, the maximum distance identifying function is labelled MaxDistance( ). MaxDistance( ) can be implemented by using Dijkstra's algorithm starting at p_{b} and terminating once all vertices in b have been visited. Other methods for obtaining maximum distance are also permitted.

The system can then get a distance between two blocks, namely blocks A and B. This distance can be the network distance between the representative vertex of A and the representative vertex of B. This network distance can be obtained by any shortest path calculation.

In FIG. 2, the block distance identifying function is labelled GetDistance( ). GetDistance( ) can obtain the network distanced between the representative vertices r_{A} for A and r_{B} for B, namely d=d_{O}(p_{A},p_{B}). The CH method is a one choice to obtain these values, but any other network distance method is acceptable.

After obtaining the radius of the two blocks, r_{A} for A and r_{B} for B, and the distance d between the two representative vertices, the system can test whether

$$\frac{{r}_{A} + {r}_{B}}{d} \leq ϵ .$$

If so, then the acceptance criterion can be met, as the effect of local variation within the blocks is sufficiently smaller than the distance between blocks.

Referring to FIG. 1, the method can also include, at 120, precomputing distances between the selected subset of vertices. This precomputation can be accomplished by the block distance identifying function mentioned in connection with FIG. 2 or by any other suitable means.

The precomputation can rely on reusing representative vertices that have been determined for each quadtree block that is considered. This reuse of representative vertices may help to reduce computation and improve scalability of the method.

The method can further include, at 122, storing the precomputed distances in all-store distance oracles. For example, the method can additionally include, at 125, storing the precomputed distances using a hash structure. The distance oracles can be stored in a high density file system.

The method can further include, at 130, answering a travel query based on the precomputed distances in the all-store distance oracles. The travel query can involve at least one of a distance query, a time query, or a fuel consumption query. A travel query can also broadly include other geographic queries, such as real estate proximity queries and the like.

The above method can be variously embodied using one or more different architectures. For example, an architecture for answering spatial analytical queries may be optimized for performing a large number of distance queries on the road network. In particular, there can be two such architectures, whose features can be compared to one another.

The first architecture is a hybrid architecture that can use a database to store and query spatial datasets, but then can use an external module that loads the road network in the main memory and performs fast in-memory scans on the road network. This approach takes advantage of the large amount of available memory in modern computers as well as the high number of processing cores to be able to compute a large number of scans quickly. An analysis tool can coordinate the data transfer and the issuance of scans to the road networks.

The second architecture can incorporate the road network inside the database as a single relation. The road network can be stored as a distance oracle relational table indexed by a B-tree. Scans on the road network can become lookups on a B-tree index. Such index lookups can be performed efficiently. This method may relay on being able to perform the queries entirely inside a database and on using the declarative nature of, for example, an RDBMS to automatically optimize queries.

In an integrated architecture, all components and procedures can reside in a database. This approach may have provide an architecture that is more compact and efficient, as the analytical query can execute entirely within the database. The database can know how to optimize such queries, since the road representation can appear as one or several relations in the database. Thus, the query may appear like any other relational query to the database. Certain embodiments, therefore, provide a suitable way of embedding the road representation in the database.

More particularly, certain embodiments can rely on an integrated architecture that makes use of an error-limited distance oracle (ϵ-DO). The distance oracle can take a road network as input, and can reduce the road network to a single database relation that captures the network distances between every pair of vertices in the road network, for example as described above and in the articles incorporated herein by reference. The technique can be based on the notion of spatial coherence, which can be described using the following example. The network distance between any vertex (more generally any location denoted by its latitude and longitude) in the Washington, D.C. region to any vertex in the Boston, Mass. region can be reasonably approximated by a single distance value. This is because the shortest path regardless of where one starts in the DC region or wants to go in the Boston region ends up using I-95N. This large overlap in the shortest paths means that the network distance between sources in Washington, D.C. and destinations in Boston, Mass. can be approximated by a single value with a bounded approximation or error tolerance. Furthermore, as the sources and destinations get farther apart, one can approximate even larger regions of sources and destinations with a single value. For instance, Maryland and California can be approximated by a single value with a bound on the approximation error since the sources and destinations are quite far from one another.

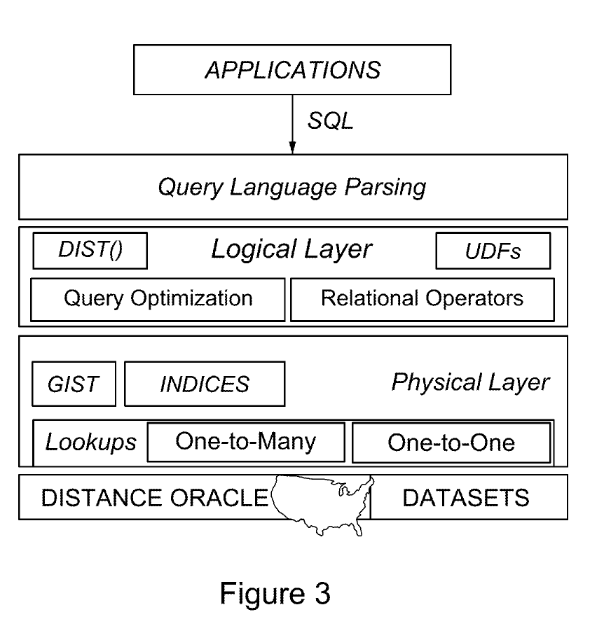

FIG. 3 illustrates an integrated architecture distance oracle for analytical queries, according to certain embodiments. Using the distance oracle, an integrated architecture can be provided as illustrated in FIG. 3.

In this case, a distance oracle road representation can be embedded in a database as a simple relational table as shown in the datasets portion of the physical layer. To query the distance oracle, a SQL function called DIST( ) can be applied. This function, in the logical layer, can query the distance oracle relational table to compute the road distance between any source and destination. In particular, given two latitude/longitude pairs, DIST( ) first can compute a unique code which it looks up in the distance oracle relational table, and then can use a simple SELECT query that is facilitated by a B-tree index. For example, computing the network distance between the White House and the US Capitol Building in Washington, D.C. can be accomplished by a query, such as the following query: “SELECT DIST(38.8977, −77.0366, 38.8898, −77.0091);”. The output may be 2144.7 (meters).

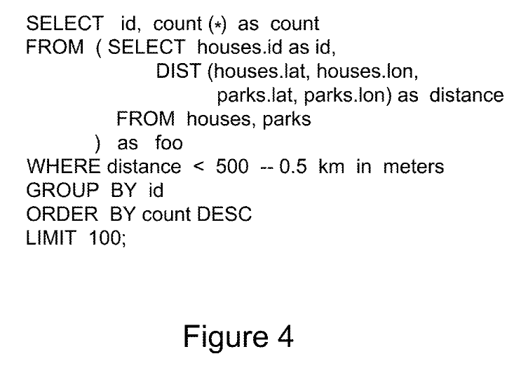

More user-defined functions (UDFs) and complex queries can also be easily expressed using the distance oracle. For example, one can provide a relation “houses (id, lat, lon)” corresponding to the location of all houses available for sale and another relation “parks(id, lat, lon)” corresponding to the location of all parks, where lat and lon correspond to the latitude and longitude values of the corresponding locations. To find up to 100 houses with the maximum number of parks that lie within 0.5 km of road distance from the houses sorted by the number of such parks, the code shown in FIG. 4 written completely in SQL can yield an efficient response. Thus, FIG. 4 illustrates an example of SQL coding of a query, according to certain embodiments.

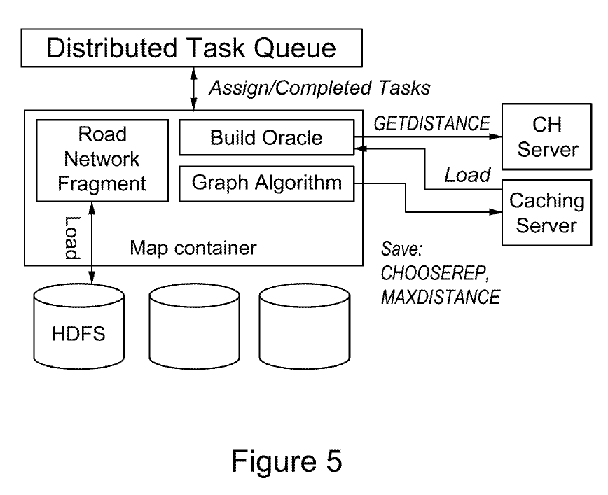

Similarly, the architecture for precomputing an all-store distance oracle can be variously embodied. FIG. 5 illustrates a distributed architecture for precomputing an all-store distance oracle, according to certain embodiments. As shown in FIG. 5, a distributed task queue can assign and keep track of completed tasks. A main process, which can be parallelized, can load road network fragments from high density file storage (HDFS). A graph algorithm can implement functions, such as those described above, to obtain results of functions for choosing representative vertices and determining maximum distance values for those vertices, and can store those results in a caching server. The caching server can return them to an oracle building function. The oracle building function can rely on a distance finding server, such as a CH server to obtain distances between representative vertices.

As the size of the computation becomes larger, a distributed architecture may be useful for computation of the oracle, since such computation may take a long time with a single machine. The quadtree structure used to represent the oracles lends itself to partitioning of the workload. For example, the task of examining each potential oracle is largely a data independent task. Thus, the distributed architecture of FIG. 5, or any similar architecture, may be used to distribute the load.

Since precomputation is a long running process, Hadoop can be used for its in-built fault recovery feature. A bank of machines can handle network instance queries needed during pre-computation. As mentioned before, a CH algorithm can be run on these machines, which is why they can be referred to as CH servers in FIG. 5, although other algorithms are also permitted. The process serving these machines can be referred to as a load balancer.

A caching service can also be run on the same CH servers for saving and retrieval of information about (p_{A}, r_{A}). Alternatively, other servers can be used as the caching servers. The caching servers can act as key-value stores, where the Morton code of the blocks form the keys. A distributed queue can be used for task assignment.

The precomputation step can be divided into, for example, two steps. In the first step, the CH servers can load the graph in their main memory and perform extensive graph operations. The goal here may be to load the graph once, use it many times and store auxiliary information for use later.

In the second step, the map tasks can simply query the CH servers, without requiring any graph information. Since in this framework the state information is stored in the queue, unless the queue fails the map process can terminate and restart.

In the first stage of computing, ChooseRep( ) and MaxDistance( ) can be computed for each block A and the result can be saved to the caching server. The road network can be broken into a plurality of blocks, such that each block fits in the main memory of a corresponding machine.

This block can be loaded from HDFS into the main memory where it can reside until the first stage is complete. A representative vertex can be selected either by choosing a vertex near the geographic center or the graph center. Once the representative is determined, the diameter or radius of the block can be calculated by, for example, applying Dijkstra's algorithm. The representative vertex for each block and the corresponding radius can be saved in the caching server.

The block can then be subdivided and processing can be continued until the leaf nodes are reached. Thus, for every block in the quadtree, a representative vertex and its radius can be stored.

In the second stage of processing, the distributed queue can be populated with potential oracles corresponding to an initially chosen depth, for example, if a depth of 4 is chosen, the queue may be initialized with 16 potential oracles.

Starting with the root potential oracle (S, S) may be unnecessary, as the block is quite large and intuitively may never be needed in any accepted oracle. Additionally, the initial depth may be chosen so that the graph representation corresponding to the block fits in the main memory of the machine. For larger blocks it may be more difficult to compute the representative vertices and the radius.

Computing the oracle can start by requesting a potential oracle from a queue. The oracle checking can invoke ChooseRep( ), MaxDistance( ), and GetDistance( ) calls by making requests to the CH servers.

Finally, the system can check if the potential oracle satisfies the WSP property, as explained above. If the potential oracle does not satisfy this properly, then it can be decomposed into its 4×4 children potential oracles. The children potential oracles can then be inserted into the queue. Otherwise, the potential oracle can be saved, for example, saved to the HDFS as an accepted oracle. When the process finishes, an ASDO can have been computed and can be loaded into a database. If desired, the ASDO can be loaded into a database in parts, even before the process fully finishes.

Given a source location p₁=(lat₁, lng₁) and a destination location p₂=(lat₂, lng₂), traditionally computing the shortest distance between the source and destination requires two steps: (1) find the nearest road vertices s, t to p₁ and p₂ respectively; and (2) calculate the network distance between s and t. The first step required a query to a spatial index (for example, a k-d tree, quadtree, R-tree, or the like) to obtain the nearest vertex, after which the network distance can be obtained by traversing the graph information.

Using an ASDO method according to certain embodiments of the present invention, the system can directly take the source and destination locations to obtain the network distance. Thus, step (1) can be obtained without significant new computation.

Once ASDO has been computed, the system can load the ASDO into a table in a relational database system. A schema of the oracle is given by (code, d), where code is a succinct representation of the accepted oracle and d is the approximate network distance. There is no need to redefine the comparator operators, for example < and =, while searching for a code using the B-tree in certain embodiments.

The principle of encoding an accepted oracle as a four-dimensional Morton block can be illustrated with a simpler two-dimensional example, Z₂. If there were a number of various length Morton codes in two-dimensions, it may be important, for a point p, to efficiently find a unique block A containing p. The uniqueness property comes here from the property of WSP, which guarantees that there is exactly one block containing p. This search problem is equivalent to finding mc(A) such that PREFIX (mc(A), mc(A)).

One approach might be to truncate one of the Morton blocks to be the same length as the other block and then checking if they are the same value. Truncating the blocks to make them the same length, however, may involve overloading and/or redefining a comparison operator.

Instead of truncating one of the blocks, certain embodiments of the present invention make all the blocks have the same length by padding them with enough zeros, so that all blocks are always of the same length, for example 2·L bits long in two-dimensions. For any block A, padding with zeros may be equivalent to choosing a unit-sized block that is a descendant of A in the quadtree that has the smallest Morton code.

A four dimensional Morton code can be obtained by interleaving mc(A) and mc(B) two digits at a time. This packing is given by the function Z₄ (A, B). A function, Z₄⁰(A, B), can be defined by padding Z₄ (A, B) with zeros to the right side.

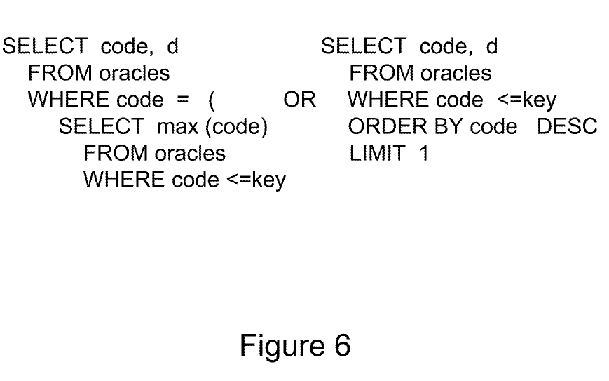

This packing, Z₄⁰(A, B), can produce a Morton code of 4·L bits length. This can form the code attribute of the relation which is indexed by a B-tree. At this point, given a source location pᵢ and a destination location p₂, the approximate network distance query can first calculate key=Z₄⁰(mc(p₁),mc(p₂)) in O(1) time, and then can issue either of the queries illustrated in FIG. 6.

FIG. 6 illustrates two queries according to certain embodiments. The queries of FIG. 6 may be extremely efficiently answered by a B-tree index on code. This approach can leverage the key property of WSP. For any two points in the domain S, there is exactly one WSP containing them.

In certain embodiments, all the codes can be stored at the same level. Thus, there may be no need to store depth information about the code. This may avoid the need for packing and unpacking of Morton codes. Thus, certain embodiments can simply treat the codes as integer numbers.

In choosing a suitable value of L, one consideration is that if L is less than or equal to 16, the Morton code Z₂ can fit in an integer. Having a longer Morton code does not affect correctness but significantly increases the size of the oracle due to use of long instead of integer.

The quadtree can safely be truncated at a depth of 16 or less for most road networks. For instance, for the US dataset, using a depth of 14 can provide a resolution of 200 meters.

With a B-tree index on the code attribute, the approximate network distance can be obtained in one look-up using the B-tree. However, there are stores that do not support the MIN/MAX operator. Example of such stores are some primitive key-value stores that provide a restricted hash-table-like interface. A simple way to query such stores is to make log n lookups. This can be done by forming keys out of all parent blocks that contain the source and the destination locations, as there are exactly log n of such keys, which may be less than or equal to 16. An efficient strategy can be to provide a way to perform a binary search on the depths of the blocks in the quadtree.

In detail, for each code Z₄(A, B), its prefix strings can be inserted for all quadtree depths. For example, for Z₄(A, B)=00110101, Z₄(A, B), 0011 and 0 can be inserted into the database. In this strategy, when users test if a Morton code exists at a certain quadtree depth, then the answer can also indicates where the search should be continued. The number of lookups needed may be O(log log n). Because the number of active levels may be less than 16 for road networks, the number of lookups may typically be 3 or 4.

The distance oracle can be mapped to a hash structure that can be implemented on top of Spark using a resilient distributed dataset (RDD). The distance oracle can store the Morton codes in sorted order inside a RDBMS by using a B-tree index structure and redefines the comparator operator. Each source-target query can perform a tree lookup in the B-tree which takes O(log n) I/O operations. This method may be well suited to disk-based systems that store the distance oracles on disk pages.

However, the distance oracle can also be mapped to a hash structure which is memory resident. This is in contrast with a B-tree which is typically good for disk-based access.

The construction of a distance oracle can create a tree structure, referred to as the DO-tree, such that its leaves form the block pairs which make up the distance oracle. As mentioned above, the distance oracle can be constructed by taking a PR quadtree on the spatial positions of the vertices. A block pair formed by the root of the PR-quadtree can form the root block of the DO-tree. At each step of the distance oracle construction, a block pair can be tested as to whether the block pair forms a Well-Separated Pair (WSP). This can be done by checking the ratio of the network distance between two representative vertices, one drawn from each of the block. pairs, to the network radius of the blocks.

If the block pairs form a WSP by virtue of the radius being greater than, for example

$$\frac{2}{ϵ} ,$$

then further decomposition can be halted. This block pair can form a leaf block of the DO-tree. If the block pair is not a WSP, then the block pair can be decomposed into 16 children block pairs, which can be tested for satisfaction of the WSP condition. The block pairs that do not form a WSP correspond to the non-leaf blocks in the DO-tree. Due to the nature of how the DO-tree is constructed, each non-leaf node of the DO-tree has 16 children nodes. Furthermore, the maximum depth D of a leaf node in the DO-tree can be the same as the input PR-quadtree. A block pair at depth D in the DO-tree corresponds to leaf blocks in the PR-quadtree, each containing a single vertex. The block pairs trivially form a WSP, as the exact network distances are recorded for these cases. Not all the leaf blocks in the DO-tree are at depth D, however.

As discussed above, there exists exactly one leaf block that contains the source and the destination. Finding the leaf may require generating all possible leaf nodes that can possibly contain the source and destination, starting with the smallest possible leaf node.

The hash table [symbol] ₁ can be constructed using only the leaf nodes of the DO-tree. Because the leaf nodes correspond to different blocks in the PR-quadtree, they can form a unique four-dimensional Morton code. The hash table can use the four dimensional Morton codes as the key and the approximate network distance as the value. A simple way to find the desired leaf node using such a hash table is to make (D+1) lookups.

Given a source s and a destination t, a 4-dimensional Morton code can be made at depth D containing both s and t. The system can test to see if [symbol] ₁ contains this key. If so, then the approximate network distance of s and t can be obtained. If [symbol] ₁ does not contain the key, the system can check whether [symbol] ₁ contains the parent of the block pair. The parent can be obtained by performing a bit-shift operation in O(1) time. Thus, the search process is guaranteed to find a key within D+1 lookups.

Alternatively, another hash table [symbol] ₂ can store both the leaf and non-leaf nodes of the DO-tree. Although it may be desired to find the leaf node containing a source and a destination, the non-leaf nodes can be used in order to guide the search process. The leaf node can be found by performing a binary search on the depths of the DO-tree. Given a source s and a destination t, a four-dimensional Morton code can be generated of s and t at depth D/2. If the hash table contains the key, then one of two options is possible: the key corresponds to a non-leaf node in the DO-tree or to a leaf node. However, at this stage it may not be possible to distinguish between leaf and non-leaf. However, a check can be performed to determine that no other node exists at a deeper depth.

For example, another Morton code can be generated at a depth between (D/2, D). This can be repeated until a nodes is found having no children blocks in [symbol] ₂. Because this process is a binary search on the depths of the DO-tree, the number of lookups is can be O(log D).

In contrast to [symbol] ₁, which could support concurrent lookups, the hash table [symbol] ₂ can only perform sequential lookups. This may be because finding or not finding nodes in the hash table informs how the search proceeds in the next step. However, [symbol] ₂ can result in far fewer lookups compared to [symbol] ₁ because the number of lookups has been reduced to O(log D) from O(D). In almost all cases D is bounded by O(log n), which means that [symbol] ₁ provides O(log n) access, while [symbol] ₂ provides O(log log n) access to the distance oracle.

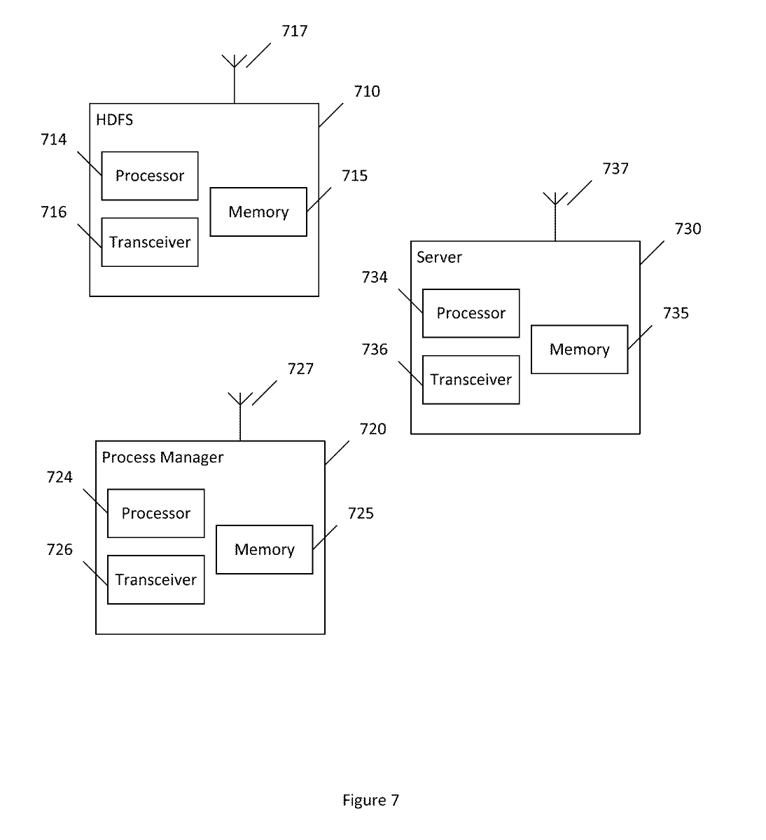

FIG. 7 illustrates a system according to certain embodiments of the invention. In one embodiment, a system may include multiple devices, such as, for example, at least one HDFS 710, at least one process manager 720, and at least one server 730. Each of these devices may include at least one processor, respectively indicated as 714, 724, and 734. At least one memory can be provided in each device, and indicated as 715, 725, and 735, respectively. The memory may include computer program instructions or computer code contained therein. The processors 714, 724, and 734 and memories 715, 725, and 735, or a subset thereof, can be configured to provide means corresponding to the various blocks of FIG. 1.

As shown in FIG. 7, transceivers 716, 726, and 736 can be provided, and each device may also include an antenna, respectively illustrated as 717, 727, and 737. Other configurations of these devices, for example, may be provided. For example, each of the devices may be configured for wired communication, instead of wireless communication, and in such a case antennas 717, 727, and 737 can illustrate any form of communication hardware, without requiring a conventional antenna.

Transceivers 716, 726, and 736 can each, independently, be a transmitter, a receiver, or both a transmitter and a receiver, or a unit or device that is configured both for transmission and reception.

Processors 714, 724, and 734 can be embodied by any computational or data processing device, such as a central processing unit (CPU), application specific integrated circuit (ASIC), or comparable device. The processors can be implemented as a single controller, or a plurality of controllers or processors.

Memories 715, 725, and 735 can independently be any suitable storage device, such as a non-transitory computer-readable medium. A hard disk drive (HDD), random access memory (RAM), flash memory, or other suitable memory can be used. The memories can be combined on a single integrated circuit as the processor, or may be separate from the one or more processors. Furthermore, the computer program instructions stored in the memory and which may be processed by the processors can be any suitable form of computer program code, for example, a compiled or interpreted computer program written in any suitable programming language.

The memory and the computer program instructions can be configured, with the processor for the particular device, to cause a hardware apparatus such as HDFS 710, process manager 720, and server 730, to perform any of the processes described herein (see, for example, FIG. 1). Therefore, in certain embodiments, a non-transitory computer-readable medium can be encoded with computer instructions that, when executed in hardware, perform a process such as one of the processes described herein. Alternatively, certain embodiments of the invention can be performed entirely in hardware.

Furthermore, although FIG. 7 illustrates a system including a HDFS, process manager, and server, embodiments of the invention may be applicable to other configurations, and configurations involving additional elements. For example, not shown, additional HDFSs may be present, and additional servers may be present, as illustrated in the remaining figures.

Certain embodiments may provide various benefits and/or advantages. For example, certain embodiments may provide twenty times more throughput than previous systems. Additional benefits are documented, for example, in “Analytical Queries on Road Networks: An Experimental Evaluation of Two System Architectures,” by Peng and Samet in Proceedings of the 23nd ACM International Conference on Advances in Geographic Information Systems (November 2015), which is hereby incorporated herein by reference in its entirety.

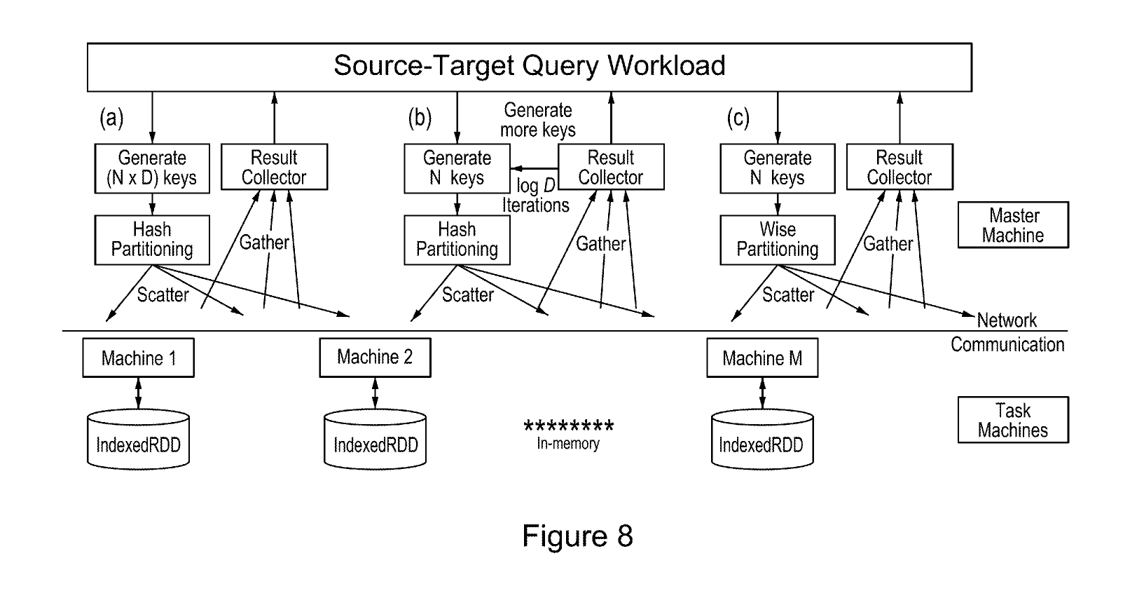

FIG. 8 illustrates cluster-computing implementations of methods according to certain embodiments. In the illustrated example, the computing cluster is a Spark computing cluster, but the same principles may be applied to other computing clusters similarly. As shown in FIG. 8, the cluster may include a single master machine (illustrated in the upper half of the figure) and M task machines (illustrated in the lower half of the figure).

The computing cluster can be configured to evaluate a large number of network distance queries which are posed as a large set containing N source-target pairs. This workload can be generated by an analytical query, but for the purpose of ease of illustration, the setup here is that the workload is available as a comma separated value (CSV) file of source and destination locations stored in HDFS. The distance oracle for a large road network has also been precomputed and is stored on the HDFS. Associated with each task machine is an in-memory high performance key-value store abstraction called IndexedRDD, which caches part of the distance oracle in its memory. The keys in this case are the four dimensional Morton codes corresponding to the node in the DO-tree and the values are the corresponding approximate network distances.

Spark can use an arbitrary hash partitioning method to distribute the nodes of the DO-tree uniformly across all M task machines. The abstraction indexedRDD can be implemented by hash-partitioning the entries by key and maintaining a radix tree index called PART within each partition.

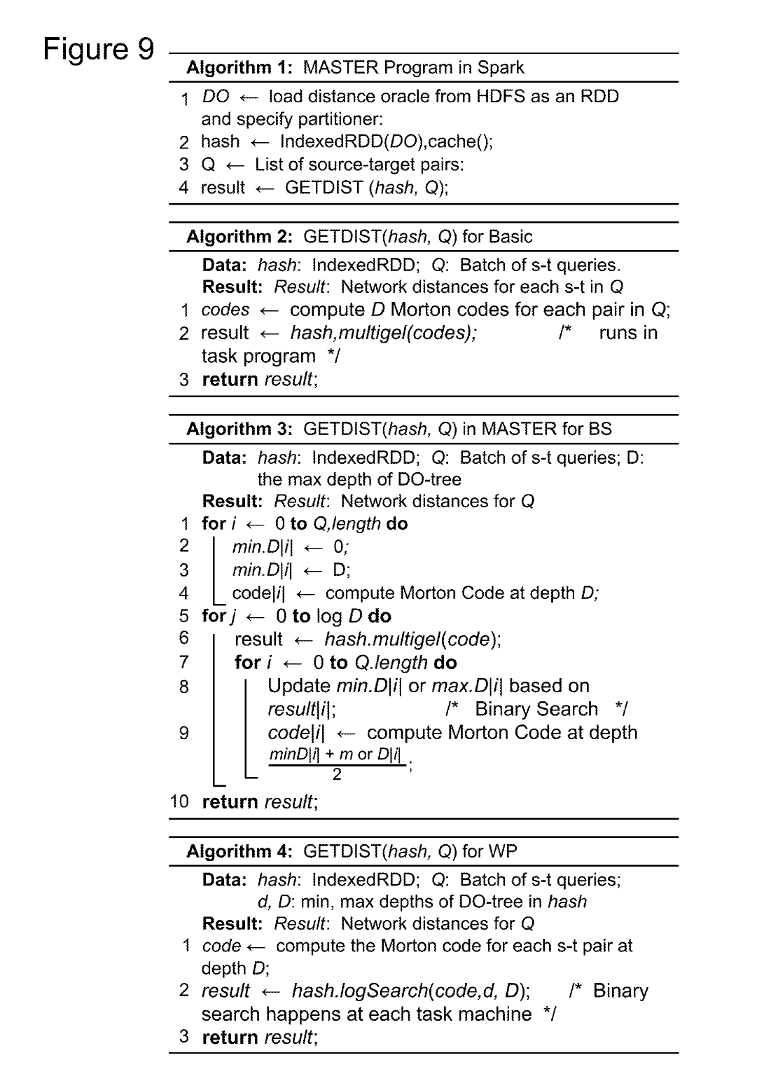

A Spark program can include master and a task programs. FIG. 9 illustrates algorithms for master programs, according to certain embodiments. Algorithm 1 in FIG. 9 provides an abstraction of the master program such as may be applied in the implementations of FIG. 8. By contrast, the working in the task program of each task machine in FIG. 8 can be the key search in its corresponding IndexedRDD, where the keys are assigned by the master machine. In the following discussion, three variants on Algorithm 1 are discussed, which may only differ from one another with respect to how a GetDistance( ) function is implemented.

A simple way to implement a distributed hash table [symbol] ₁ is to expand each of the N source-target pairs into their D four-dimensional Morton keys. This relies on the concurrent aspect of [symbol] ₁, which can ensure that all the D accesses can be made concurrently but only one of the keys will find a key in the hash table. The master machine can read N source-target pairs from HDFS, form (N×D) keys, and can assign the keys to M task machines through a hash partitioning method. The hash partitioning method can be the same as the one used to distribute the nodes of the DO-tree uniformly across all M task machines. Next, each task program can check if the assigned sets exist in its local hash map, such as IndexedRDD. Next, the task program can report the keys that it found along with their corresponding values, namely approximate network distances, to the master. Finally, the master can collect the results from the M task machines and can return the results to the user. There may be no need to check if the master obtained two distance values for a source-distance pair or if it missed finding one.

Section (a) of FIG. 8 illustrates the flow plan of a basic method in Spark with one master machine and M task machines, corresponding to Algorithm 2 in FIG. 9. In particular, after the precomputation of ϵ-DO, there can be

$$O ( \frac{n}{{ϵ}^{2}} )$$

WSPs. In the setup stage, an arbitrary hash partitioner can be defined in Spark, denoted as HP, to randomly partition the WSPs into M task machines. Each task machine can load the corresponding WSP set into its memory, and can then build a local HashMap for the WSP set using IndexedRDD. In the query stage, when the master machine receives N source-target pairs, it can form (N×D) keys and can scatter the keys through the HP.

Section (b) of FIG. 8 illustrates a binary search method corresponding to Algorithm 3 in FIG. 9. The binary search (BS) method can be an implementation of [symbol] ₂, which can retrieve a shortest network distance using O(log D) operations.

The task program in BS can be exactly the same as in the basic method, except that the HashMap, for example IndexedRDO, can contain both the leaf and non-lead nodes in the OD-tree. When the master program receives the N source-target pairs as inputs the master program can first generate the Morton codes corresponding to depth D. These N Morton codes can be provided to the M task programs by a hash partitioning method that checks for their existence. If a key is found in the hash table, then the search process is done, as any node found in the hash table at depth D in the DO-tree is a leaf node. The value of the key found is the approximate network distance.

If a key is not found at depth D, then a Morton code corresponding to depth

$$\frac{D}{2}$$

can be generated for the source-target pair. If the task program finds the key in the hash table, then the task program can return the success of finding and the value of the key. The master program in turn can issue a new query with a key corresponding to Morton code at depth

$$\frac{3 D}{4} .$$

In general, the new depth can be the middle value of the depths that have been tried in the previous two iterations, such that one search resulted in a success and the other in a failure. The search can continue until it finds a depth d that is present in the hash table and a depth d+1 that is not present. This process can continue log D times, because a binary search is being performed on the D depths of the OD-tree.

Section (c) of FIG. 8 illustrates a binary search method corresponding to Algorithm 4 in FIG. 9. Section (c) and Algorithm 4 illustrates a so-called wise partitioning (WP) method.

Both the basic and the BS methods have an issue, which is that the workload of the master machine is much higher than that of the task machines. In the BS method, each task machine receives

$$\frac{N}{M}$$

keys at each iteration but the master needs to collect N keys and issue further queries. Because each task machine simply looks up a local hash map, their computational workload is much smaller than that of the master machine. In the case of the basic method, the master machine may need to generate D·N keys and process N results, while each of the task machines may simply process

$$\frac{1}{M}$$

of the workload.

To make the workload more balanced, for example to increase the workload of the task machines, the default hash partitioner HP can be replaced with a new partitioning method, referred to as the wise partitioner (WP). The wise partitioner can improve on the BS method by moving the log D iterations into the tasks. In particular, in the BS method, the default hash partitioner HP randomly and uniformly scatters the queries among the M tasks during the task setup stage. The HP function can uniformly distribute the keys among the M task machines and in that sense does not preserve any locality in the data. Because of this, considering one s-t pair, the D keys in the basic method and the log D keys in the BS method would likely be present on different task machines. This is also the reason that the master machine takes on a heavy workload in the Basic and BS methods, as it may need to coordinate the search among multiple task machines, collect results from all the task machines, and even generate new keys to try out in the case of the BS method.

To move all of the log D iterations into the task machines, each task machine may need to ensure that all of the keys for a given s-t query are contained in its local hashmap or none of it should be present in the local hash map. The wise partitioner algorithm can achieve the partitioning of

$$O ( \frac{n}{{ϵ}^{2}} )$$

WSPs into M task machines such that all of the D keys for each s-t query are hashed to the same task machine.

The WP can take advantage of the presence of the non-leaf nodes in the DO-tree, which can help find the leaf nodes corresponding to WSP nodes. WP can be constructed as follows.

First, the DO-tree can be truncated at depth d to obtain a forest of subtrees. Depth d can be chosen so that there are no leaf nodes at a depth less than d. All the non-leaf nodes that are at a depth less than d can be discarded. The number of subtrees in the forest can be greater than M and typically much greater than M. Larger blocks at lower depths tend not to form a WSP with other larger blocks. If the value of d results in fewer subtrees than M, then a larger value of d can be chosen, and those leaf blocks can be further sub-divided until they reach a depth of d.

Although choosing a value of d may appear to be a trial and error process, the value can be selected so as to decompose the DO-tree into at least M subtrees

Once the DO-tree has been decomposed into subtrees, an entire subtree can be assigned to the same task machine, while the subtrees themselves are assigned using HP. Each subtree can be stored in a local hash map and the BS method can now finds the leaf nodes and its ancestors in the same task machine. Task machines can perform a binary search as before, except that the depth ranges from [d, D] instead of [0, D]. The task machine can check to see if there is a key for a source-target pair at depth D. If it is not found, then the task machine can check at depth

$$\frac{d + D}{2}$$

and so on, until log(D−d+1) iterations have been performed. At this point, the distance value can be communicated to the master machine.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1. A method, comprising:
selecting a subset of vertices from a provided set of vertices;
precomputing distances between the selected subset of vertices;
storing the precomputed distances in all-store distance oracles; and
answering a travel query based on the all-store distance oracles.

2. The method of claim 1, wherein the travel query comprises at least one of a distance query, a time query, or a fuel consumption query.

3. The method of claim 1, further comprising:
building a point region quadtree corresponding to the provided set of vertices.

4. The method of claim 1, further comprising:
selecting the subset of vertices as representative vertices of respective blocks of the provided set of vertices.

5. The method of claim 4, wherein the selected subset of vertices are selected in well separated pairs.

6. The method of claim 5, wherein the selecting representative vertices comprises selecting a geographic center of a block.

7. The method of claim 4, wherein the selecting representative vertices comprises selecting a graph center of a block.

8. The method of claim 4, wherein the selecting representative vertices comprises selecting either a graph center of a block or a geographic center of the block, depending on a number of vertices in the block.

9. The method of claim 1, further comprising:
storing the precomputed distances using a hash structure.

10. The method of claim 9, wherein the hash structure contains both leaf nodes and non-leaf nodes.

11. The method of claim 1, wherein the method is performed in an integrated architecture.

12. An apparatus, comprising:
at least one processor; and
at least one memory including computer program code,
wherein the at least one memory and computer program code are configured to, with the at least one processor, cause the apparatus at least to
select a subset of vertices from a provided set of vertices;
precompute distances between the selected subset of vertices;
store the precomputed distances in all-store distance oracles; and
answer a travel query based on the all-store distance oracles.

13-14. (canceled)

15. A non-transitory computer-readable medium encoded with instructions that, when executed in hardware, perform a process, the process comprising the method according to claim 1.

16. The apparatus of claim 12, wherein the travel query comprises at least one of a distance query, a time query, or a fuel consumption query.

17. The apparatus of claim 12, wherein the at least one memory and computer program code are further configured to, with the at least one processor, cause the apparatus at least to build a point region quadtree corresponding to the provided set of vertices.

18. The apparatus of claim 12, wherein the at least one memory and computer program code are configured to, with the at least one processor, cause the apparatus at least to select the subset of vertices as representative vertices of respective blocks of the provided set of vertices.

19. The apparatus of claim 18, wherein the selected subset of vertices are selected in well separated pairs.

20. The apparatus of claim 18, wherein selection of the representative vertices comprises selecting either a graph center of a block or a geographic center of the block, depending on a number of vertices in the block.

21. The apparatus of claim 1, wherein the at least one memory and computer program code are configured to, with the at least one processor, cause the apparatus at least to store the precomputed distances using a hash structure.

22. The apparatus of claim 21, wherein the hash structure contains both leaf nodes and non-leaf nodes.
